(19) United States
(12) Patent Application Publication
(10) Pub. No.: US 2011/0231433 A1
(43) Pub. Date: Sep. 22, 2011

(54) Management system, management method, and temporary storage document server

(75) Inventors: Yasuhiro Tabata, Kanagawa (JP); Takashi Yano, Tokyo (JP); Katsuyuki Kaji, Tokyo (JP); Kenta Nozaki, Tokyo (JP)

(73) Assignee: Ricoh Company, Limited, Tokyo (JP)

(21) Appl. No.: 13/064,079

(22) Filed: Mar. 4, 2011

(30) Foreign Application Priority Data
Mar. 17, 2010 (JP) 2010-061576
Dec. 27, 2010 (JP) 2010-289253

(51) Int. Cl. G06F 17/30

(52) U.S. Cl. 707/769; 707/E17.014

(57) ABSTRACT

A management system includes a document management server that receives an electronic document or the like in a client connected to a network together with predetermined metadata, a temporary storage document server that communicates with a briefcase provided in the Metaverse world and temporarily stores therein an electronic document or the like created or received in the Metaverse world together with predetermined metadata, a transmission unit that transmits an electronic document or the like and metadata in the temporary storage document server to the document server, and a transmission function of transmitting a Corresponding electronic document or the like to the client by searching metadata and/or electronic documents and the like as targets based on search bibliographic data transmitted from the client. The temporary storage document server includes a metadata acquisition unit that acquires predetermined metadata of a document when the document is temporarily stored in the client.

### CROSS-REFERENCE TO RELATED APPLICATIONS

The present application claims priority to and incorporates by reference the entire contents of Japanese Patent Application No. 2010-061576 filed in Japan on Mar. 17, 2010 and Japanese Patent Application No. 2010-289253 filed in Japan on Dec. 27, 2010.

### BACKGROUND OF THE INVENTION

1. Field of the Invention

The present invention relates to a method of managing electronic documents and the like in a unified manner and a management apparatus that manages electronic documents and the like, in particular, relates to a document management apparatus that manages electronic documents and the like in a plurality of worlds.

2. Description of the Related Art

Conventionally, as methods of storing a document, there are the following methods if simply classified: a method of storing a document in a form of paper in a book stack, a storage box, or the like; and a method of storing an electronic document that is electronically created by a personal computer or the like in a storage apparatus of the personal computer or a portable storage apparatus such as a USB memory or storing such electronic document in a document server through a network. Furthermore, in order to utilize the above documents, the following method is conventionally employed: classifications are assigned to the documents themselves or classifications are assigned to document files and documents to be put into the same category are collectively stored.

In recent years, storage methods are employed in a selective manner. For example, confidential classifications are assigned to documents and highly confidential documents are stored in a lockable archive and non-confidential documents are stored in a place that cannot be not necessarily locked. In a case of electronic documents, related electronic documents are stored in a classified electronic file. In this case, access restriction can be set onto highly confidential documents themselves. With such access restriction, highly confidential documents cannot be accessed by an unauthorized person even if such highly confidential documents and other documents are stored in the same file.

As described above, storage methods are present in parallel in each of the real world and the electronic world. Documents of the same category are stored in different places even in the same world in consideration of confidentiality in some cases. Recently, various business models utilizing a three-dimensional virtual space called the Metaverse have been figured out (for example, see, Japanese Patent Application Laid-open No. 2004-178257). That is to say, it can be considered that a document is created in the Metaverse, the document is exchanged between avatars.

Documents that are to be put into the same category normally are separately stored and managed even in the real world and the electronic world. In addition, if the Metaverse is added to the both, documents are further distributed. By using advanced techniques that have been developed in recent years, the age in which electronic documents are frequently exchanged as follows is supposed to come sooner or later: electronic documents created in the Metaverse can be transmitted to the electronic world or the real world, and electronic documents are transmitted from the real world or the electronic world to the Metaverse world.

If that age comes, there arises a problem that a trouble in searching a document occurs. In other words, a document or data to be used cannot be easily retrieved no matter when or where a user wants. Even if all the documents in the real world are digitized and are made present in the electronic world, the documents cannot be unified in the Metaverse for particular reasons.

That is to say, logging in with a password is specially required in order to enter the Metaverse world. Documents in the Metaverse are accessed in a different manner from electronic documents stored in a typical document server present in the world of the Internet or LAN. In other words, the Metaverse is managed under an environment different from a network environment that is typically used in an office. Therefore, electronic documents are not shared between both of the worlds at present.

Then, documents, data, videos, and the like that are digitized in the same manner cannot be retrieved easily by single searching, resulting in inconvenience.

Furthermore, even when there is a storage unit that centrally manages electronic documents and the like in the different worlds, a document or the like that a user wants to retrieve is required to be retrieved from the storage unit appropriately and quickly. A method of assigning classifications to electronic documents and the like that are loaded by different input units one by one and storing the electronic documents and the like is a reliable method surely. However, the method requires efforts for assigning the classifications. Furthermore, it is increasingly difficult to assign integrated classifications to the electronic documents and the like because the input units thereof are different from each other. If a personal computer is used, a classification list can be easily referred because the personal computer is connected to a network. However, when a digital camera or the like that is normally unconnected to a network is used, it is difficult for the digital camera itself to have a classification list that is possibly changed in real time or as needed.

### SUMMARY OF THE INVENTION

It is an object of the present invention to at least partially solve the problems in the conventional technology.

According to an aspect of the present invention, a management system includes: a document management server; and a temporary storage document server that stores therein an electronic document created or received in a Metaverse. The document management server includes: a document storage unit that stores therein an electronic document and metadata transmitted from a terminal device and the temporary storage document server in a correspondence manner; and a first transmission unit that transmits the electronic document searched from the document storage unit based on a search key transmitted from the terminal device to the terminal device. The temporary storage document server includes: a temporary storage unit that stores therein an electronic document created or received in the Metaverse and metadata in a correspondence manner; and a second transmission unit that transmits the electronic document and metadata stored in the temporary storage unit to the document management server.

According to another aspect of the present invention, a management method that is executed in a management system including a document management server, and a temporary storage document server that stores therein an electronic document created or received in a Metaverse includes: a document storage process in which the document management server stores an electronic document and metadata transmitted from a terminal device and the temporary storage document server in a document storage unit in a correspondence manner; a first transmission process in which the document management server transmits the electronic document searched from the document storage unit based on a search key transmitted from the terminal device to the terminal device; a temporary storage process in which the temporary storage document server stores an electronic document created or received in the Metaverse and metadata in a temporary storage unit in a correspondence manner; and

a second transmission process in which the temporary storage document server transmits the electronic document and metadata stored in the temporary storage unit to the document management server.

According to still another aspect of the present invention, a temporary storage document server in a management system includes: a document management server; and the temporary storage document server that stores therein an electronic document created or received in a Metaverse. The document management server includes: a document storage unit that stores therein an electronic document and metadata transmitted from a terminal device and the temporary storage document server in a correspondence manner; and a first transmission unit that transmits the electronic document searched from the document storage unit based on a search key transmitted from the terminal device to the terminal device. The temporary storage document server includes: a temporary storage unit that stores therein an electronic document created or received in the Metaverse and metadata in a correspondence manner; and a second transmission unit that transmits the electronic document and metadata stored in the temporary storage unit to the document management server.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an entire system construction for carrying out an embodiment of the present invention;

FIG. 2 is a view for explaining a three-dimensional virtual space office used in the embodiment;

FIG. 3 is a view illustrating one scene in a three-dimensional virtual client office;

FIG. 4 is a view for explaining functions of a virtual multifunction peripheral;

FIG. 5 is a view illustrating an example of functions of an MFP in the real world and an MFP in the virtual world;

FIG. 6 is a view for explaining an example of the embodiment;

FIG. 7 is a view illustrating a Metaverse address book;

FIG. 8 is a view illustrating a list of electronic documents and the like stored in a briefcase used in the embodiment;

FIG. 9 is a flowchart illustrating operations of automatic classification of an electronic document or the like according to another example of the embodiment;

FIG. 10 is a view illustrating an input screen on which a classification of an electronic document or the like is registered according to another example of the embodiment;

FIG. 11 is a table illustrating correspondence relationships between metadata and classification codes used in the embodiment;

FIG. 12 is a view illustrating a configuration of a management system of electronic documents and the like in a plurality of worlds according to the embodiment;

FIG. 13 is a table illustrating metadata items for each electronic document used in the embodiment;

FIG. 14A is a view illustrating an input screen for searching an electronic document according to the embodiment;

FIG. 14B is a view illustrating a screen on which a search result is displayed according to the embodiment; and

FIG. 15 is a flowchart illustrating operations of transmission and storage of an electronic document according to the embodiment.

### DETAILED DESCRIPTION OF THE PREFERRED EMBODIMENTS

Hereinafter, an embodiment of a document management apparatus according to the present invention is described in detail with reference to the accompanying drawings.

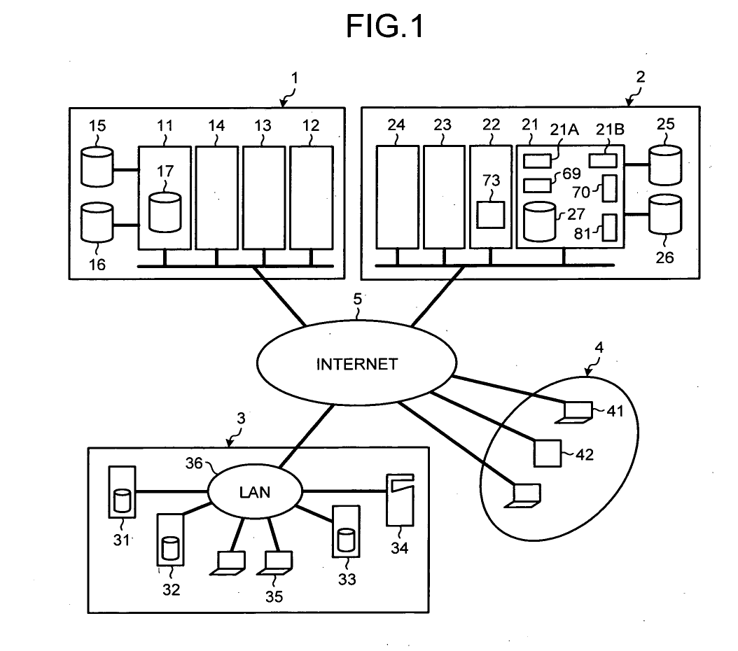

FIG. 1 is a view illustrating an entire system construction according to the embodiment. The entire system includes a public three-dimensional virtual space provider site 1, a private three-dimensional virtual space provider site 2, a client site 3, and a user site 4.

The public three-dimensional virtual space provider site 1 is a site managed by a provider that provides a three-dimensional virtual space to an unspecified number of users or contracted users. For example, Second Life (registered trademark of Linden Lab, Inc.) managed by Linden Lab, Inc., US is an example of the public three-dimensional virtual space provider site 1. The public three-dimensional virtual space provider site 1 includes a public three-dimensional virtual space management server 11, a user connection management server 12, a user authentication server 13, and a log management server 14.

Each of a public object DB (database) 15 and a public virtual space DB (database) 16 is connected to external sides of the public three-dimensional virtual space management server 11. Furthermore, a three-dimensional virtual space 17 is constructed in the public three-dimensional virtual space management server 11 by using data of the above two DBs.

The user connection management server 12 manages connection with user PCs such that users perform desired activities in the public three-dimensional virtual space.

The user authentication server 13 of the user authenticates the user based on an ID, password, and the like so as to permit the user to access to the public three-dimensional virtual space.

The log management server 14 is configured to record activities of the user in the public three-dimensional virtual space.

Next, the private three-dimensional virtual space provider site 2 is described. The private three-dimensional virtual space provider site 2 is a site managed by a provider that provides a private three-dimensional virtual space to a contracted client company.

The client company can use the private three-dimensional virtual space as spaces for intraverse, CRM, SCM and the like by a contract.

The private three-dimensional virtual space provider site 2 includes a private three-dimensional virtual space management server 21, a user connection management server 22, a user authentication server 23, and a log management server 24.

Each of a private object DB (database) 25 and a private virtual space DB (database) 26 is connected to external sides of the private three-dimensional virtual space management server 21. Furthermore, a three-dimensional virtual space 27 is constructed in the private three-dimensional virtual space management server 21 by using data of the above two DBs.

The user connection management server 22 manages connection with user PCs such that users perform desired activities in the private three-dimensional virtual space. The user connection management server 22 includes a transmission unit 73 that transmits voice or character information bidirectionally. With the transmission unit 73, a user can have a conversation with the other person in real time.

The user includes a user in a client company and a user (individual or company) that deals with the client company.

The user authentication server 23 of the user authenticates the user based on an ID, a password, and the like so as to permit the user to access to the public three-dimensional virtual space.

The log management server 24 is configured to record activities of the user in the public three-dimensional virtual space.

A corporate avatar automatic creation unit 21A in the private three-dimensional virtual space management server 21 forms an appearance of a corporate avatar. A dynamic information management unit 21B manages a state of the corporate avatar at the present time. A static information display unit 70 displays static information of the corporate avatar on a screen. The static information indicates information that is unique to the avatar, such as a name, belonging (including a name of a company), a post, a phone number, a FAX number and a mail address in the real world.

Next, the client site 3 is described.

The client site 3 is basically constructed by a corporate intranet. The client site 3 includes an ERP server 31 as a core system, a document management server 32 as an information system, a groupware server 33 including mail, scheduler and workflow, a multifunction peripheral (MFP) 34 such as a multifunctional printer, and terminals 35 such as a number of personal computers (PCs) for users in the company. These components in the client site 3 are connected to a LAN 36. The LAN 36 is connected to the Internet 5.

It is to be noted that although electronic data on the terminals 35 are permitted to be newly created in the client site 3, electronic data may be prohibited to be replicated. For example, the terminals 35 are configured so as to install only software that only permits electronic data to be newly created. Alternatively, the terminals 35 may be configured as thin clients, so that software that cannot replicate electronic data on the groupware server 33 is executed by the terminals 35 as thin clients. If electronic data is prohibited to be replicated on the terminals 35, when a user replicates electronic data, the user is required to use a virtual MFP, which will be described later, to replicate the electronic data. With this configuration, the user cannot freely create replication of electronic data. When the replication is needed, the user consciously replicates the electronic data by using the virtual MFP consciously or transmits the electronic data to another avatar, thereby realizing enhanced security.

Next, the user site 4 is described.

The user site 4 is an unspecified number of users for the public three-dimensional virtual space provider or the private three-dimensional virtual space provider. The user site 4 is constituted by a plurality of personal computers (PCs) 41 of the contracted users. The personal computers 41 are connected to the Internet 5.

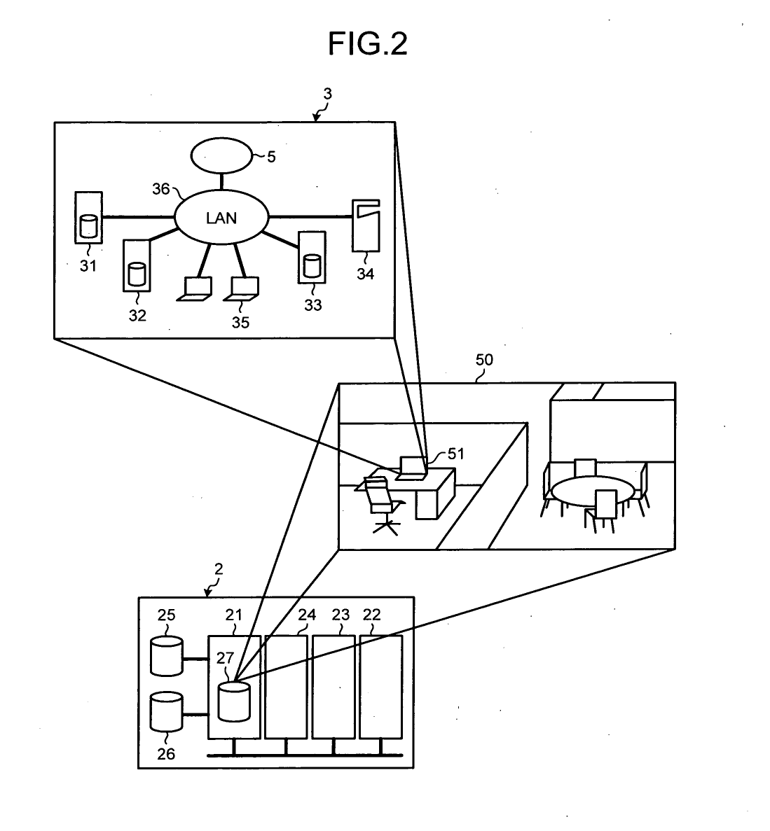

Next, a three-dimensional virtual space office 50 used in the embodiment is described with reference to FIG. 2.

The three-dimensional virtual space office 50 is formed in the three-dimensional virtual space 27 in the private three-dimensional virtual space management server 21 in the private three-dimensional virtual space provider site 2. Avatars of users in a client company or avatars of users that deal with the client company work in the three-dimensional virtual space office 50.

A personal computer (PC) 51 of a user in the three-dimensional virtual space office 50 is connected to the LAN 36 in the client site 3. As in the client (not illustrated) in the real world, the client site 3 includes the ERP server 31 as a core system, the document management server 32 as an information system, the groupware server 33 including mail, scheduler and workflow, the multifunction peripheral (MFP) 34 such as a multifunctional printer, and the number of terminals 35 for users in the company. These components in the client site 3 are connected to the LAN 36. The LAN 36 is connected to the Internet 5.

All of the three-dimensional virtual client office 50 and the client site 3 are virtual.

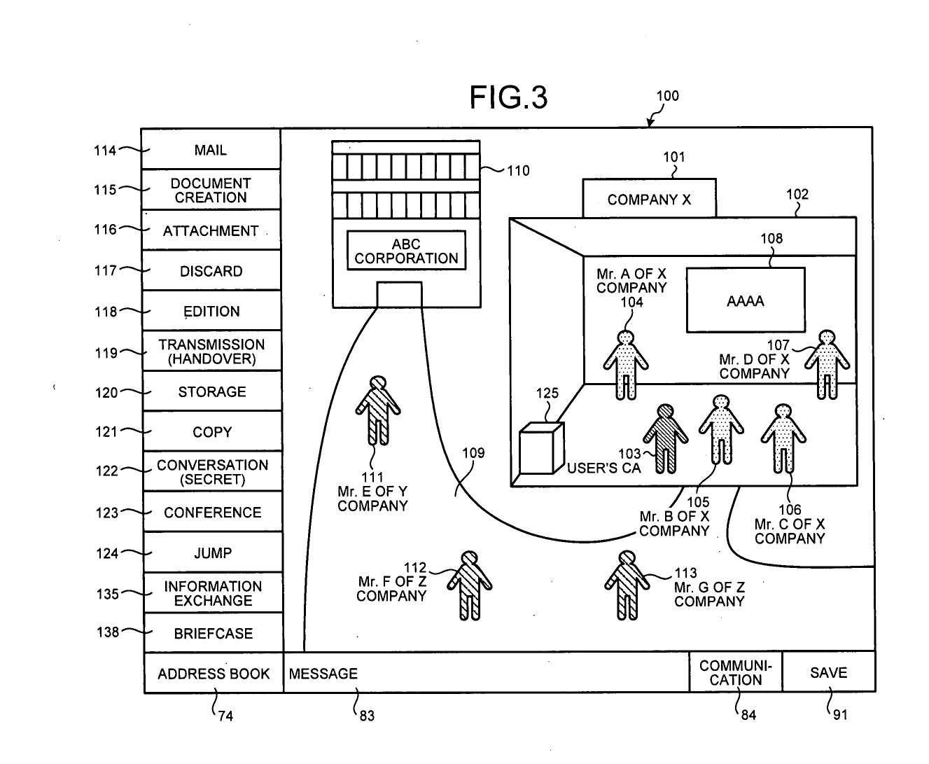

Next, an example of the three-dimensional virtual client office 50 is described with reference to FIG. 3.

A company X 101 and a virtual conference room 102 in the company X 101 are displayed on a three-dimensional virtual space screen 100. A user's corporate avatar 103, and corporate avatars Mr. A 104, Mr. B 105, Mr. C 106, and Mr. D 107 who are employees of the same company X are present in a virtual office of the company X 101. The five members are in a conference in the virtual conference room 102 in the company. A virtual space display panel 108 that is used in the conference is attached in the virtual conference room 102. The company X is formed in a part of a city and an ABC corporation 110 is formed at an end of a street 109. A corporate avatar Mr. E 111 of a Y company and corporate avatars Mr. F 112, and Mr. G 113 of a Z company are walking on the street 109.

The corporate avatars are colored by a coloring unit 69 (see, FIG. 1), which will be describes later. Corporate avatars of other companies are colored with blue, for example, that is different from a color of the avatars of a user's company. Therefore, corporate avatars of the user's company and those of other companies can be apparently distinguished from each other. It is needless to say that colors added to the corporate avatars can be arbitrarily determined.

The example is a three-dimensional virtual space that is not limited to the user's own company only and is provided on the public three-dimensional virtual space provider site 1 illustrated in FIG. 1. Various types of functions that are the same as those described with reference to FIG. 1 are provided on each of the servers 11 through 14, the public object DB 15, and the public space DB 16. Since the functions thereof are the same as those in FIG. 1, detail description is not repeated.

Action buttons that are necessary for various corporate activities performed in the virtual office are prepared on the left side on the three-dimensional virtual space screen 100. A mail button 114, a document creation button 115, an attachment button 116, a discard button 117, an edition button 118, a transmission (handover) button 119, a storage button 120, a copy button 121, a conversation (secret) button 122, a conference button 123, and the like are prepared in this order from the top. In addition, although not illustrated in FIG. 3, action buttons for teleconference, termination, temporary halt, start, and the like are prepared.

The corporate avatars can not only have a conversation between the corporate avatars but also do various works in the three-dimensional virtual world by the above action buttons.

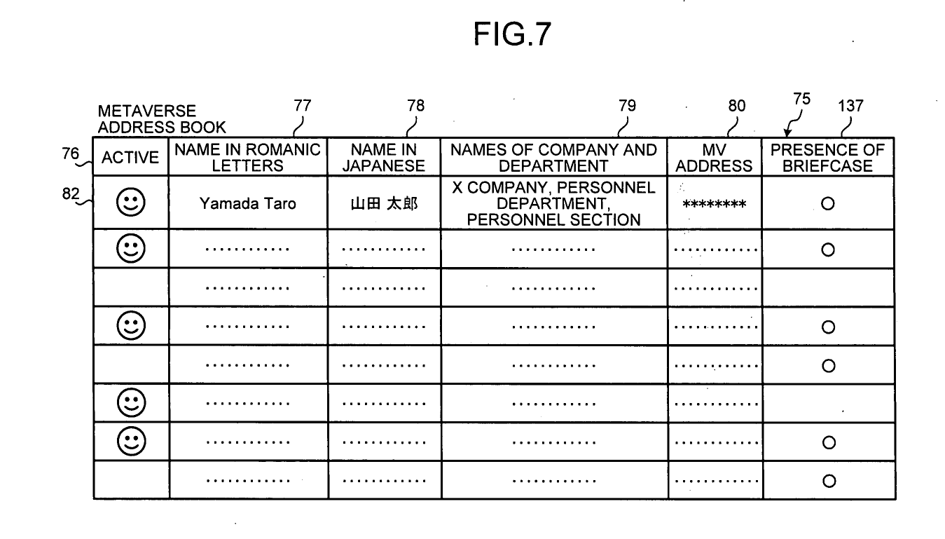

First, if the mail button 114 is pressed, a menu screen is displayed and various functions including mail creation, mail reading, mail edition, and mail transmission can be selected. If any one of the functions is selected, a screen that is appropriate for executing the function is displayed and each processing can be executed. When the mail transmission is selected, if an address book button 74 is pressed, a Metaverse address book 75 illustrated in FIG. 7 is displayed so as to be used.

Furthermore, a user's avatar can also jump or move to a place where a corporate avatar to which the user's avatar wants to send a created mail is present so as to hand over the mail to the corporate avatar during a conversation without transmitting the mail thereto. In such a case, if the transmission (handover) button 119 is pressed, a selection screen for selecting destination selection or handover is displayed on a menu screen. Then, if the handover is selected and an action is executed, a mail document that the user's avatar has at this time is handed over to the other corporate avatar. This is convenient when the user's avatar wants the other corporate avatar to not only have a conversation but also keep contents as a document. The other corporate avatar can read the mail document instantly and complement the document through the conversation or the like, thereby improving efficiency of the work. When a corporate avatar to which the user's avatar wants to send a mail is absent, it is sufficient that the user's avatar transmits and leaves the mail. It, can be judged whether a corporate avatar is present in an active field 76 as illustrated in FIG. 7 by utilizing the Metaverse address book 75.

Furthermore, as described above, when the corporate avatar with which the user's avatar wants to communicate is turned out to be present in the virtual space office, and the user's avatar wants to have a conversation with the corporate avatar directly, the user's avatar specifies the corporate avatar and presses a jump button 124. Then, the user's avatar can jump to a place near the corporate avatar instantaneously.

If the document creation button 115 is selected, a document can be created in the virtual space office. For example, a document can be created by utilizing Word, Excel (registered trademark of Microsoft Corporation), or the like manufactured by Microsoft Corporation. The attachment button 116 has a function of attaching another document or the like to the created document. The discard button 117 has a function of discarding an unnecessary document among created documents, stored documents, and documents received from other corporate avatars. Because the transmission (handover) button 119 has been already described, description thereof is not repeated. The storage button 120 has a function of storing a document or the like created or received in a recording unit of the user's avatar. The copy button 121 has a function of simply replicating a document or the like that the user's avatar has. These functions are simpler than those of a multifunction peripheral having a specific function, which will be described later.

If the user's avatar specifies an avatar and presses the conversation (secret) button 122, the user's avatar can be made into a conversation mode. When the conversation (secret) button 122 is pressed, a menu screen is displayed at first and conversation (open) or secret conversation can be selected. As already described in detail, description thereof is not repeated. If the conference button 123 is selected, the user's avatar can be made into a conference mode with two or more corporate avatars. If the conference button 123 is pressed, a menu screen is displayed so as to guide the user's avatar to select corporate avatars who should participate in the conference. At this time, the user's avatar can select the corporate avatars as follows: the user's avatar can select the corporate avatars by clicking them with a mouse simply when the corporate avatars are gathered around the user's avatar. Alternatively, the user's avatar can specify the corporate avatars by selecting “selection” from the Metaverse address. book. Furthermore, corporate avatars may select to participate in the conference by themselves. However, there are a conference in which anyone can participate freely and a conference in which only specified corporate avatars are permitted to participate. Such conferences are distinguished into an open conference and a limited conference. In the case of the limited conference, it is preferable as a typical procedure that a corporate avatar as an organizer specify corporate avatars that participate in the conference and the specified corporate avatars participate therein. In the case of the open conference, it is sufficient that corporate avatars set to participate in the conference by themselves.

A message can be transmitted as in the same manner as normally transmitted e-Mail and left in a mail server of a recipient by writing the message on a message field 83 and pressing a communication button 84. When a conversation is ended, if the user's avatar wants to save all the conversation information as a record, the conversation information can be saved in the log management server 24 by pressing a save button 91 at the right side of the communication button 84.

Next, a virtual multifunction peripheral is described. A virtual MFP 125 as a virtual multifunction peripheral is arranged in the virtual conference room 102. Facilities and equipment such as the virtual MFP 125 and the virtual space display panel 108 can be purchased in shops in the virtual space. It is needless to say that such facilities and equipment can be produced by avatars themselves. Since the purchasing or production of the facilities and equipment are performed normally in Second Life or the like, detail description thereof is omitted.

Townscape, buildings of companies, organization layout in the company, and the like are recorded in the public space DB 16 and the private virtual space DB 26 (see, FIG. 1).

If the new virtual MFP 125 is clicked on the screen, various functions of the virtual MFP 125 are displayed in the vicinity thereof.

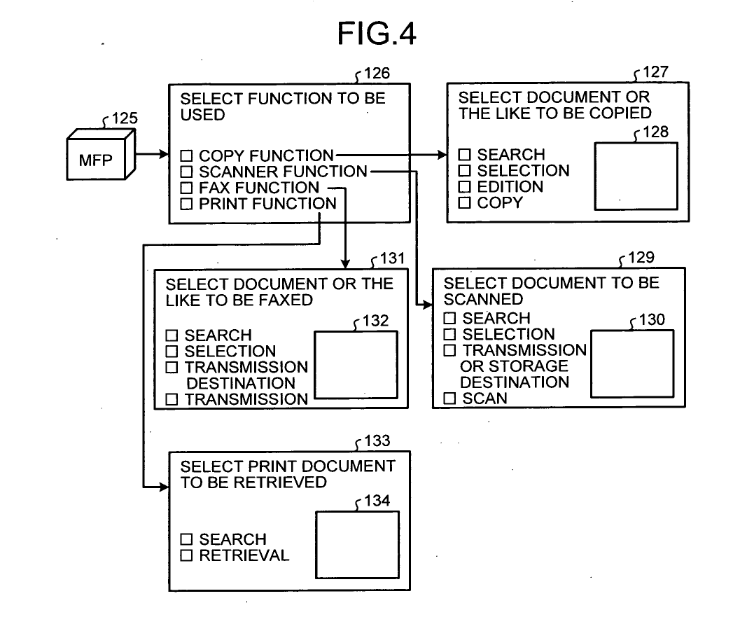

The functions of the virtual MFP 125 are described with reference to FIG. 4. If the virtual MFP 125 is clicked, a function list menu screen 126 is displayed. As a typical example, on the first menu screen 126 as illustrated in FIG. 4, a message “select a function to be used” is displayed, and four functions of a copy function, a scanner function, a FAX function, and a print function are displayed under the message so as to be selected.

If the copy function at the top is selected, a copy function menu screen 127 is displayed. Then, a message “select a document or the like to be copied” is displayed on the copy function menu screen 127 and functions of search, selection, edition, and copy are displayed under the message so as to be selected. The search function is a function of searching a document to be copied from a document server (not illustrated) or a document storage unit (not illustrated) of the user in the virtual space. The search result is displayed on a window 128. An appropriate document is selected from a plurality of documents. The document may be selected by a selection button or by clicking the document with a mouse. Then, the selected document is copied. Note that by selecting the edition function before the document is copied, edition directions such as color, monochrome, duplex, collective copy, shading, and post processing (binding) can be displayed on the window 128. Finally, if a copy function button is pressed, copy (replication) in accordance with the edition directions can be performed in the virtual space.

Next, if the scanner function is selected, a menu screen 129 is displayed. A message “select a document to be scanned” is displayed on the menu screen 129 and functions'of search, selection, transmission or storage destination, and scanning are displayed under the message so as to be selected. Since the search and selection are the same as in the above copy function, description thereof is not repeated. If the transmission or storage destination is selected, an avatar to which the scanned document is transmitted or a place in which the scanned document is stored can be specified. The Metaverse address book 75 is displayed on a window 130 and the transmission destination is selected therefrom. Then, the scanning function button is pressed, so that the scanned document is transmitted to the transmission destination. If the storage destination is selected, a document server or a storage device in which the scanned document is to be stored can be selected on the window 130.

If the FAX function is selected, a menu screen 131 is displayed. A message “select a document or the like to be faxed” is displayed on the menu screen 131 and functions of searching, selection, transmission destination, and transmission are displayed under the message so as to be selected. If the transmission destination is pressed, the Metaverse address book 75 is displayed on a window 132. Then, if the user checks a FAX number (whether the FAX number is registered on the Metaverse address book 75) and presses a transmission button, the document is transmitted.

Finally, a case where the print function is selected is described. However, the print function is different in a role from the copy function. To print a document that is being created or has been created by a user, it is sufficient that the user presses the copy button 121 illustrated in FIG. 3. The print function referred here indicates a function of searching and retrieving a document that another corporate avatar or a person in the real world has transmitted to the user. If the print function is selected, a menu screen 133 is displayed. A message “select a print document to be retrieved” is displayed on the menu screen, and functions of search and retrieval are displayed under the message so as to be selected. If the search function is pressed, only electronic documents and the like that have been transmitted to the user are displayed on a window 134. In other words, documents that have been transmitted to other persons cannot be retrieved for a security reason. The user specifies a necessary document from a plurality of documents and presses the retrieval button, so that the document can be retrieved.

In the above configuration, the virtual MFP 125 displays the menu screen 126 if the corporate avatar clicks the virtual MFP 125. However, in place of the configuration, a configuration in which a shape of an operation panel of an MFP in the real world is displayed on a screen and various functions on the operation panel are specified to make an edition direction can be employed. The transmission or storage destination can be specified in the same manner as described above. With the method, functions of the multifunction peripheral in the real world can be directly displayed. Therefore, there is an advantage in that a user can execute copying or the like while checking a desired function.

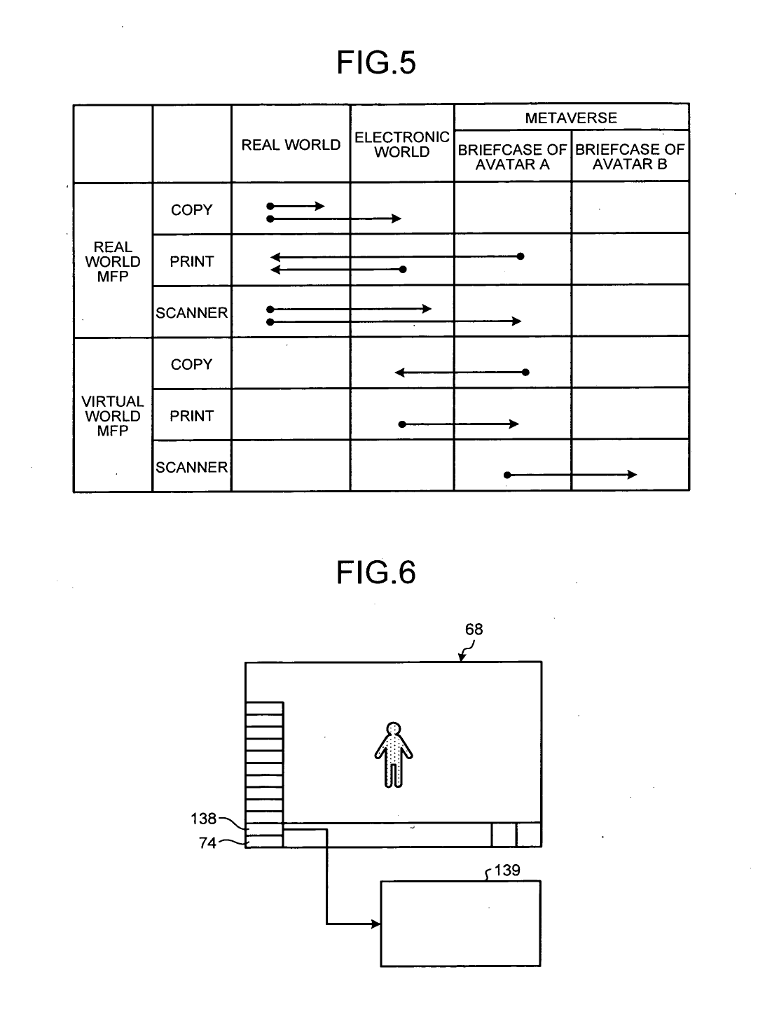

Here, functions of the MFP in the real world and the virtual MFP 125 are described. FIG. 5 is a view for explaining differences between the functions of the MFP in the real world and those of the virtual MFP 125. FIG. 5 indicates that an electronic document is output with each function from a world (the real world, electronic world, or Metaverse) corresponding to a position indicated by a black circle to a world corresponding to a position indicated by a nock end of an arrow. It is to be noted that relationships between output sources and output destinations of a document with respect to the functions illustrated in FIG. 5 are only examples, and output sources and output destinations may be set differently from those illustrated in FIG. 5.

As illustrated in FIG. 5, the MFP in the real world has a copy function, a print function and a scanner function, for example. If the copy function is executed by the MFP in the real world, for example, a paper medium obtained by copying a document in the real world is output in the real world. By executing the copy function, an electronic document obtained by digitizing the document in the real world may be output to the electronic world. Furthermore, printing can be executed from any of the electronic world and the Metaverse to the MFP in the real world (print function). If the scanner function is executed by the MFP in the real world, an electronic document obtained by scanning and digitizing a document in the real world is output to the electronic world or the Metaverse.

On the other hand, if the copy function is executed by the virtual MFP 125, an electronic document stored in a virtual storage unit (virtual storage unit), such as a briefcase, in the Metaverse can be copied to the electronic world. As described above, an electronic document may be copied in another storage unit in the Metaverse. If the print function is executed by the virtual MFP 125, an electronic document that has been transmitted to the user is retrieved in the virtual storage unit, such as a briefcase, in the Metaverse from the electronic world as described above. If the scanner function is executed by the virtual MFP 125, an electronic document stored in a briefcase, for example, is output to a specified storage destination such as a briefcase of another avatar.

The above actions can be executed by creating a virtual multifunction peripheral (virtual MFP 125) having substantially the same functions as the multifunction peripheral in the real world. That is to say, the virtual multifunction peripheral is connected to the multifunction peripheral in the real world in the one-to-one relationship. In addition, the virtual multifunction peripheral has main edition functions of the multifunction peripheral in the real world. However, although the multifunction peripheral in the real world is required to output an actual replicated material, the virtual multifunction peripheral is not required to output an actual replicated material. Therefore, an image forming device, a fixing device, a paper conveying mechanism, and the like are not required to be provided in the virtual multifunction peripheral. In other words, a function of the virtual multifunction peripheral is limited to a function of electronically replicating.

If a manufacturer of a multifunction peripheral in the real world sells the virtual multifunction peripheral of this type as an item for a three-dimensional virtual space in the virtual space, the user can realize MFP communications between the virtual space and the real world.

There are following advantages to be obtained by using not a multifunction peripheral in the real world but a virtual multifunction peripheral. 1. The first is that a user's avatar can instantaneously move to a place where a convenient multifunction peripheral is provided in a virtual space office. 2. When a multifunction peripheral near the user in the real world is in use, a multifunction peripheral that is not in use in the virtual space can be judged and used instantly. 3. It can be judged whether a multifunction peripheral has a function that the user wants to use by clicking the virtual multifunction peripheral only. Therefore, the user is not required to go up or down, or walk far for the judgment unlikely in the real world. 4. Since the virtual multifunction peripheral does not output a replicated material actually, power saving can be realized so as to be good for the environment.

Next, another method of using the virtual multifunction peripheral in the virtual space office is described. For example, it is assumed that a user's corporate avatar transfers a copy of a document to a co-worker. In the real world, a paper document is copied with a copying machine and sent as in-house mail. Alternatively, a method in which a mail is created in a personal computer, an electronic document is searched and attached to the mail, and then, the mail is transmitted from the personal computer is employed in the real world. In the virtual space office, the virtual MFP 125 can be made into a usable state only by moving to the vicinity thereof or clicking the virtual MFP 125 if the virtual MFP 125 can be seen on a screen. For example, since an operation panel that is unique to the specified virtual multifunction peripheral is displayed, the user performs operations of searching, copying, and transmitting of a necessary document in accordance with guidance on the operation panel so as to complete the transmission of the document. If the document is received by the co-worker, the user's corporate avatar can communicate with the corporate avatar of the co-worker in real time while checking the transmitted document at the time of the reception. Furthermore, they can be put into the conversation mode by pressing the conversation (secret) button.

Conversation, conference, and teleconference modes are described. Avatars can have a conversation online in real time by checking a character display by a keyboard in the message field 83 at a lower portion of the screen. The avatars can also have a conversation with voice. Conversation with characters or conversation with voice can be set to be selected. For example, the avatars can have a conversation with voice by selecting a voice conversation mode on a menu screen displayed when the conversation (secret) button is pressed. However, it is preferable that the voice conversation mode be selected in an environment in which voice conversation can be performed, such as in a conference room, in consideratipn of a work environment of the other user. In the case of the voice conversation, all the contents of the conversation can be recorded as in the conversation with characters or the like. For example, voice conversation (with recording) or voice conversation (without recording) can be previously made to be selected when the above menu screen is displayed. When the conversation is recorded, the recorded conversation is stored in the log management servers 14 and 24. In order to search the stored conversation later, the conversation is stored with key information such as year, month and date, time, names of users who have had the conversation, and a place. With this, the conversation can be searched easily by selecting a search method on a chronological or interlocutor basis.

An effect of the most advantageous point of the virtual space office is exhibited when offices in a company are far from each other. For example, it is assumed that there are offices in Tokyo and San Francisco, US and virtual space offices of both offices are constructed in the same virtual space intranet. Although it is required to eliminate a problem of the time difference therebetween, it is assumed that a conversation is needed to be held between corporate avatars in both offices. In such a case, a user's corporate avatar in Tokyo can instantaneously move to the office in San Francisco or can instantaneously move to the vicinity of the other corporate avatar by using the Metaverse address book 75 and the jump button (function) 124. Then, the corporate avatars can communicate with each other in real time at a place to which the user's corporate avatar has moved. Furthermore, there is an advantage in that when a conference is held in the office in San Francisco, the user's corporate avatar can instantaneously move to a conference room and participate in the conference in real time. Therefore, the user can experience the conference in an atmosphere or environment as if the user participates in the conference at the same place. Accordingly, the virtual space office exhibits advantages in many points such as time (speed), moving time, moving cost, power saving, and quick decision.

Then, maintenance and management of the Metaverse address book 75 are described. A method how a corporate avatar enriches the Metaverse address book 75 thereof is described. That is to say, a method how the corporate avatar newly registers Metaverse addresses of corporate avatars with which the corporate avatar should have a conversation.

Typically, when the corporate avatars have a conversation in the virtual space office, the Metaverse address is not necessarily required because the corporate avatar can be made in a conversation mode by clicking the other corporate avatar. However, when the corporate avatar meets a distant corporate avatar in a office conference incidentally, or when the corporate avatar meets a corporate avatar of another company in an outside conference, Metaverse addresses of the corporate avatars can be exchanged with each other like buiness card exchange. For example, by providing an information exchange button 135 at a lower left portion in FIG. 3, basic entry information of the corporate avatars can be exchanged with each other. In other words, it is sufficient that exchange of the basic entry information between the corporate avatars is considered to be similar to business card exchange in the real world. However, since the basic entry information of the corporate avatars is exchanged in the virtual space, a company name, belonging, a post, a company address, a phone number, a FAX number, a mail address and a Metaverse address can be transmitted to the other corporate avatar by pressing the information exchange button 135 during the conversation. Alternatively, such information can be obtained therefrom. The obtained information is automatically recorded and stored in the Metaverse address book 75.

In such, a manner, not only the Metaverse address but also an e-mail address used in the real world are stored in the Metaverse address book 75 (see, FIG. 7). Therefore, a corporate avatar in the three-dimensional virtual space can communicate with a person in the real world by utilizing the e-mail address. Alternatively, a person in the real world can communicate with a corporate avatar in the virtual space by utilizing the obtained Metaverse address. It is needless to say that communications between avatars in different three-dimensional virtual space providers can be realized. If the age of multiverse as described above comes, it is supposed that the Metaverse address is standardized in order to realize mutual information communications.

Next, a case where a corporate avatar visits another company in the virtual space is described. As illustrated in FIG. 3, a case where a corporate avatar of the company X101 visits the ABC corporation 110 at the outside is described as an example. If the user's corporate avatar 103 visits the ABC corporation 110, the user's corporate avatar 103 goes to reception of the ABC corporation 110 first. Then, the user's corporate avatar 103 introduces himself/herself and tells the reception about a person that the user's corporate avatar 103 wants to meet. If the user's corporate avatar 103 enters a conference room provided on a common space in the company, a conference with the other corporate avatar is held. In order to prevent conversation contents in the conference room from being listened by others, the conversation (secret) mode is selected. Therefore, secrecy of the conversation contents can be protected.

Next, a briefcase of a corporate avatar is described with reference to FIG. 6.

A corporate avatar can have a briefcase. The briefcase may be set as a standard item that the corporate avatar has. However, a configuration in which the briefcase can be purchased in shops in the virtual space may be employed. As illustrated in FIG. 6 and FIG. 3, when the corporate avatar has the briefcase, a briefcase button 138 is displayed on a screen 68 at a left side. The briefcase has a function of temporarily storing therein an electronic document or the like obtained in the virtual space office and temporarily storing therein an electronic document or the like prepared for transmitting to the other person. If the briefcase button 138 is pressed, a temporary storage document list 139 indicating a list of electronic documents and the like stored in the briefcase is displayed.

For example, it is assumed that a document or a mail is transmitted to a corporate avatar in the virtual space office from the real world by using a personal computer.

As illustrated in FIG. 1, the Metaverse address book 75 is opened by using the personal computer 41 from the user site 4 in the real world so as to select the corporate avatar as a target. With a typically performed method, a mail document is created and a document or the like is attached thereto as needed so that the mail is transmitted. In this case, the other corporate avatar may be or may not be present in the three-dimensional virtual space. However, when the other corporate avatar does not have a communication unit for making communications between the real world and the three-dimensional virtual space, the communications cannot be realized. The briefcase makes it possible to realize the communications. Accordingly, whether each of registered corporate avatars has a briefcase is displayed in a briefcase presence field 137 of the Metaverse address book 75 as illustrated in FIG. 7 when the Metaverse address book 75 is opened with operation in the above transmission mode (or mail creation mode), thereby increasing the convenience. A circle marked in the briefcase presence field 137 indicates that the corresponding corporate avatar has a briefcase.

The virtual office in FIG. 3 illustrates one organization in the company X. Only corporate avatars of the X company can enter the X company, of course. As in the company entrance in the real world, corporate avatars are judged to be permitted or unpermitted by matching with data (ID and password) registered in the user authentication server 23 at an entrance or reception of the virtual office. As described above, security management in the virtual office is made in the same manner as that made in the real world.

The corporate avatars illustrated in FIG. 3 are colored as described above. Red is added to the user's corporate avatar 103, white is added to corporate avatars that are not in a conversation state, and yellow is added to corporate avatars that can have a conversation. The coloring unit 69 is provided on the private three-dimensional virtual space management server 21.

A button 74 calling the Metaverse address book (three-dimensional virtual space address book) 75 is provided on the display screen 100 displaying the above virtual office at a lower left portion.

If the Metaverse address book button 74 is selected to be clicked with a mouse button, the Metaverse address book 75 illustrated in FIG. 7 is displayed. The Metaverse address book 75 is constructed of the active field 76, a name in Roman letters 77, a name in Japanese 78, names of company and department 79, an MV (Metaverse) address 80, and the briefcase presence field 137. The Metaverse address book 75 is stored in an MV address storage unit 81 (third storage unit) in the private three-dimensional virtual space management server 21 illustrated in FIG. 1. Furthermore, although not illustrated in FIG. 7, an e-Mail address, a corporate avatar name, a FAX number, a telephone number, and the like that are used in the real world are stored together in the Metaverse address book 75 in the MV address storage unit 81. Information displayed on the screen of the Metaverse address book 75 can be set by a user previously or as needed. When the user wants to select “Yamada Taro” in the Metaverse address book 75, “Yamada Taro” can be selected by clicking the field (indicated by reference numeral 82) thereof.

Address information of all the users that contracts and joins in the private three-dimensional virtual space provider site 2 is stored in the MV address storage unit 81. In the client site 3, individual MV address books of the users may be stored in an address information storage unit (not illustrated) in the groupware server 33 or may be stored in a hard-disk of the terminals 35 of the client.

In the same manner, the MV address information is also stored in a storage unit of the three-dimensional virtual space management server 11 in the public three-dimensional virtual space provider site 1.

By sharing MV address information of various types of the Metaverse (three-dimensional virtual space) provider sites, communications between the three-dimensional virtual spaces can be realized. Furthermore, communications can be realized between the three-dimensional virtual space and the real world by specifying a mail address in the real world from the three-dimensional virtual space. In addition, communications between the three-dimensional virtual space and the real world can be realized by specifying an MV address from the real world.

Accordingly, when an operation of transmitting an electronic mail from the real world to a corporate avatar having no briefcase is mistakenly performed, the electronic mail cannot be transmitted and a message “the electronic mail cannot be transmitted because the corporate avatar has no briefcase” is displayed. When the transmission can be performed, a message “transmittable” can be displayed. These messages may not be displayed when the transmission is properly done.

If transmission of the electronic mail from the real world to the corporate avatar in the three-dimensional virtual space can be normally completed, the above document (including mail) is temporarily stored in a briefcase of the corporate avatar as a target. As illustrated in the left side of FIG. 3, the briefcase button 138 is provided. The briefcase item can be also purchased in shops in the virtual world. Software environment necessary for realizing communications between the real world and the three-dimensional virtual space is set up at the time of the purchasing. At this time, the briefcase button 138 can be set to be displayed on the user's virtual space screen.

For example, the user's corporate avatar 103 presses the briefcase button 138 on the screen, so that all of mail transmitted to the user's corporate avatar, electronic documents obtained from others, documents for transmitting to others, that the user's corporate avatar has, and the like are temporarily stored.

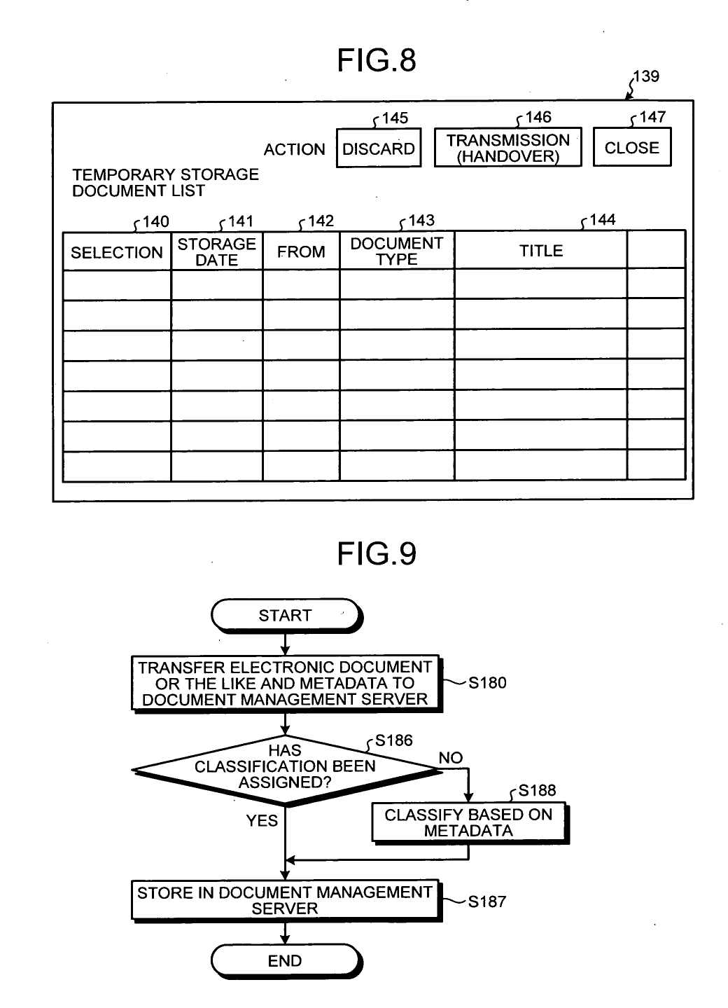

For example, if the briefcase button 138 is pressed, a list of electronic documents and the like stored in the briefcase is displayed as illustrated in FIG. 6 and FIG. 8. A selection field 140, a storage date field 141, a FROM field 142, a document type field 143, a title field 144, and the like are provided on the temporary storage document list 139. A processing is performed by selecting a document with a mouse (ticking or the like) in the selection field 140 and pressing an action button displayed on an upper portion. A discard button 145, a transmission (handover) button 146, and a close button 147 are provided as the action buttons.

Year, month and date on which an electronic document is stored in the briefcase is displayed on the storage date field 141. Time (hour, minute, and second) can be set to be displayed as needed. A transmitter of a document is displayed in the FROM field 142. Since documents that the user transmits to others are included in the temporary storage document list 139, the user's name is displayed on the FROM field 142 in some cases. A type of a document, such as an electronic mail, a word document, a photograph, or a moving image, is displayed on the document type field 143. A document title given to an electronic document is displayed on the title field 144. In the case of an electronic document having no title, information close to the title in metadata attached to the document can be previously set to be displayed.

If a document field (any position is available) displayed on the temporary storage document list 139 is clicked, contents of the document stored are displayed on the screen so as to be checked.

Next, an example relating to another transmission of a document or the like from the real world to the three-dimensional virtual space is described. In FIG. 1, a multifunction peripheral 42 that is arranged in the user site 4 in the real world is illustrated. In the example, a user transmits a document to a specified corporate avatar in a three-dimensional virtual space by using the multifunction peripheral 42. The user scans a predetermined document by using a scanner function of the multifunction peripheral 42. A procedure of specifying a transmission destination is typically included in the scanner function. In the procedure, URL, a mail address, or the like of the transmission destination is specified. At this time, if the multifunction peripheral 42 is set so as to register the Metaverse address book 75, the transmission destination can be specified therefrom. The Metaverse address book 75 may be displayed as illustrated in FIG. 8. It is preferable that a multifunction peripheral including the Metaverse address book 75 as standard equipment be arranged. If the multifunction peripheral does not include the Metaverse address book 75 as standard equipment, the Metaverse address book 75 that the user stores may be called from a server or a storage unit through a network and the transmission destination may be selected therefrom.

In order to realize more effective communications, after a document is transmitted to a corporate avatar in the virtual world as described above, the user also enters the three-dimensional virtual space provider site where the corporate avatar is present so as to realize communications in real time directly with the above corporate avatar. In this case, they can have a discussion based on the above transmitted document.

Furthermore, the corporate avatar that has received the above document can store the document in the document management server 32 (that is also provided on each of the provider sites 1 and 2 although not illustrated) that is provided on the three-dimensional virtual space for managing the documents in the briefcase with other electronic documents in the real world in a unified manner. With this, the electronic documents in the real world and documents created in the three-dimensional virtual space can be managed in a unified manner. A user in the real world specifies URL of the document management server 32 in the client site 3 illustrated in FIG. 1 so as to transmit and store an electronic document created by the user by using a personal computer.

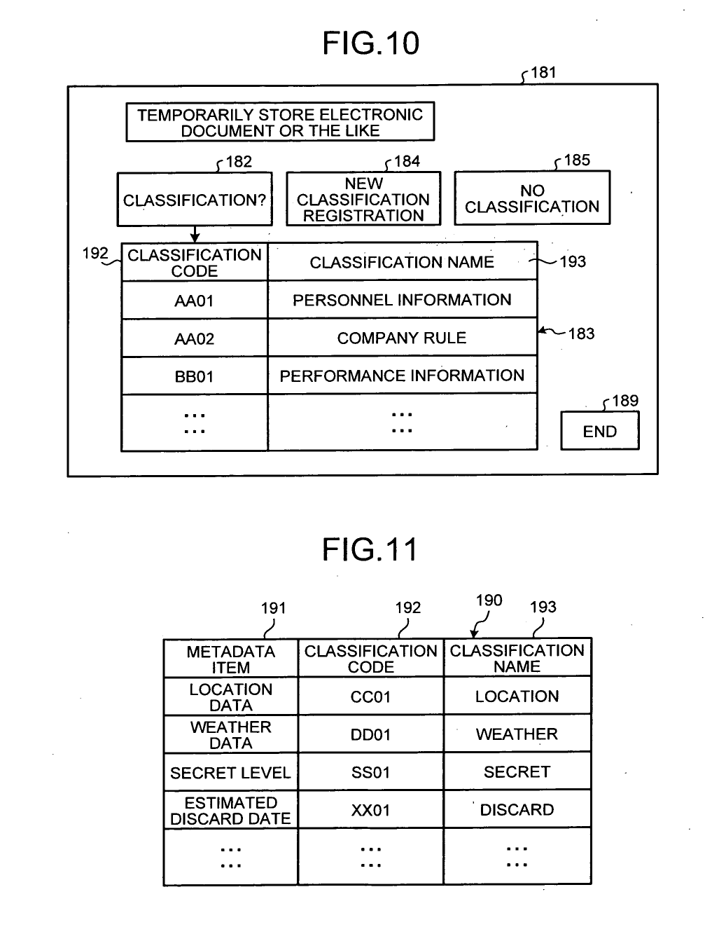

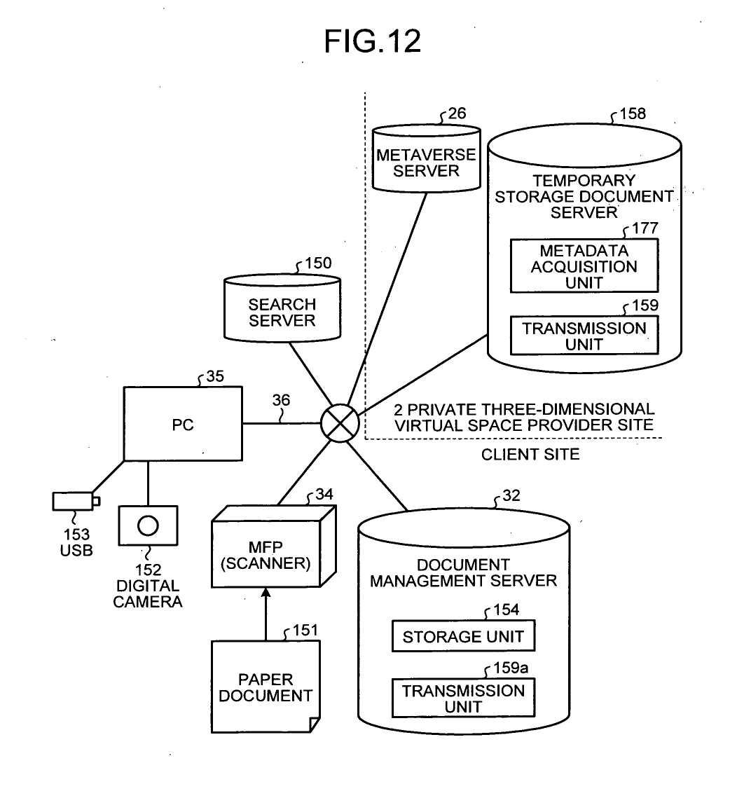

Next, automatic classification of an electronic document or the like is described with reference to FIG. 9, FIG. 10 and FIG. 12. FIG. 9 is a flowchart illustrating operations of the automatic classification of the electronic document or the like. FIG. 10 illustrates an input screen for registering classification of the electronic document or the like. FIG. 9 is a flowchart of the automatic classification when an electronic document or the like stored in a temporary storage document server 158 is transferred to and stored in the document management server 32. At first, in the flowchart in FIG. 9, a processing of transferring an electronic document or the like in the temporary storage document management server 158 to the document management server 32 is started when the avatar directs to store the document or when the avatar logs out of the Metaverse (step S180). A registered classification item list 183 is displayed on a screen 181 together with an inquiry message 182 “classification?” when the avatar stores the electronic document or the like in the temporary storage document server 158. The classification item list 183 is constructed of fields of a classification code 192 and a classification name 193. The classification item list 183 can be displayed in a pull-down manner by clicking a message field indicating the above “classification?”. If there is a corresponding classification in the classification item list 183, the classification is selected so as to assign the classification to the electronic document. It is needless to say that a plurality of classifications can be assigned to one electronic document or the like. For example, two classifications of “AA02: company rule” and “BB01: performance information” can be assigned to one electronic document.

If an appropriate classification item is not registered when a document or the like is stored, a window for classification registration is displayed (not illustrated) by pressing a “new classification registration” button 184. The registration is completed by inputting new classification on the window. It is to be noted that when the same classification as the input classification has been already registered, an error message is displayed so as to prevent the classification from being overlappingly registered. Furthermore, when a plurality of classifications are assigned to the electronic document, assignment of an already-registered classification and registration and assignment of a new classification can be performed in combination, of course. Furthermore, when classification is not needed in the immediate future, or the user wants to leave the classification to the automatic classification, the user presses a “no classification” button 185. In the flowchart, in this case, a judgment process of judging whether classification has been assigned is executed (step S186). Then, if the classification has been assigned with the above operations (Yes at step S186), the electronic document or the like is transferred to and stored in the document management server 32 together with metadata and the classification thereof (step S187).

In the above operation, if the user selects the “no classification” button 185, not a manual classification operation but an automatic classification operation by software is started. In this case, it is judged that classification has not been assigned at step S186 (No at step S186) in the flowchart, and the process shifts to a classification processing based on metadata (step S188). Note that when the electronic document or the like has been stored in the temporary storage document server 158, metadata relating to the electronic document or the like has been already acquired. The electronic document or the like is automatically classified based on the metadata. A button 189 is pressed at the end of the processing.

FIG. 11 illustrates a table indicating a correspondence relationship between metadata and a classification code. When the automatic classification is performed, a metadata item 191, a classification code 192, and a classification name 193 are previously associated with each other as illustrated in a table 190 in FIG. 11. For example, metadata relating to location data corresponds to a classification code “CC01” (location). Weather data corresponds to a classification code “DD01” (weather). Secret level data corresponds to a classification code “SS01” (secret). Estimated discard date data corresponds to a classification code “XX01” (discard). It is needless to say that these are only examples and much more metadata and classification codes can correspond to each other.

Basic flows of the automatic classification are as follows. Metadata items of an electronic document are scanned and the metadata items including data are extracted. If a corresponding item is present in the table 190, a classification code thereof is acquired and classification is assigned to the electronic document. Then, the metadata items are further scanned and if corresponding items are further present in the table 190, classification codes thereof are sequentially acquired. For example, a case in which an avatar shoots a photograph of a specific scene by using a camera in the Metaverse and stores the photograph is described. The avatar stores the photograph that has been shot in a briefcase (not illustrated), that is, stores in the temporary storage document server 158. At this time, metadata at the time of shooting the photograph including location data, creation date (shooting date), a creator (photographer), weather data, a secret level (normally set to be in an open state), and a storage deadline has been set to be assigned to the photograph with functions of the camera. When the photograph that has been temporarily stored is stored in the document management server 32, classification is assigned to the photograph. At this time, if the table 190 in FIG. 11 is used, since the location data, the weather data, the secret level, and the storage deadline (estimated discard date) are matched, classification codes CC01, DD01, SS01, XX01 are assigned to the photograph.

FIG. 12 is a view illustrating a configuration of a unified management system of electronic documents and the like in a plurality of worlds. In FIG. 12, the configuration of the client site 3 in FIG. 1 is illustrated more in detail. A reference numeral 35 denotes a terminal such as a personal computer. The terminal 35 is connected to the LAN 36. A search server 150, the multifunctional printer 34 (hereinafter, referred to as MFP), and the document management server 32 are connected to the LAN 36. The MFP 34 has four functions of a scanner, a copier, a facsimile, and a printer. It is needless to say that the MFP 34 does not necessarily have all of the four functions and the MFP 34 having the scanner function and another function may be employed. The MFP 34 can scan a paper document 151 in the real world, transmit an electronic document obtained by the scanning to the specified document management server 32 among a plurality of document management servers connected to the LAN 36, and store the electronic document therein. The terminal 35, the MFP 34, and the document management server 32 are devices provided in the real world. An electronic document (not illustrated) created by the terminal 35 can be stored in the document management server 32 connected to a network. Furthermore, various documents on the Internet are searched by using the terminal 35 and an electronic document obtained by the Internet can be stored in the document management server 32 in the same manner as described above.

Next, a method of storing an electronic document or the like in the document management server 32 is described. The electronic document or the like referred herein collectively indicates not only a normal electronic document but also an electronic image (including a moving image and a still image) and electronic data (including voice data). The electronic document or the like is normally stored in a storage device in the document management server 32 together with various bibliographic items such as date, a creator (possessor), a name of document (title), a document format, and a document capacity (size). Furthermore, not only the electronic document or the like is stored simply but also the electronic document or the like is stored in a storage region called a file with a file name in normal cases. With this, a file that a user wants to search is opened and the related electronic documents and the like in the file can be checked in a state where the electronic documents and the like are targeted at some degree without searching with a keyword or the like.

In the embodiment, not only an electronic document but also an electronic image, electronic data and the like are stored in the document management server 32 as described above. Electronic information of the above three types having each unique metadata is created. For example, date of shooting, shooting conditions, a shooting location, a photographer, correction date, reception date, and the like as metadata are attached to an electronic image shot by a digital camera or a digital video camera 152, while a title of the electronic image is not attached thereto. In the same manner, recording year and month and date and time, a recording place, a name of a target, a recording time, a person who has recorded, a recipient, and the like as metadata are attached to digital voice data. Scanning date, a scanning place, a name of a device, a person that has scanned, a transmission destination, a name of a document (that can be input as needed), and the like as metadata are attached to an electronic document of the paper document 151 scanned by the MFP 34. It is to be noted that the items of metadata as described above are only examples and do not encompass all items. Furthermore, an electronic document or the like created by another person is loaded from a portable storage medium 153, for example, a USB memory or a memory card, through the terminal 35 as illustrated in FIG. 12. In this case, a name of the document, year, month and date of creation, a creator, a secret level, an encryption key, an accessible person, reception date, a recipient, version information, a data capacity, and the like as metadata are attached to the electronic document or the like.

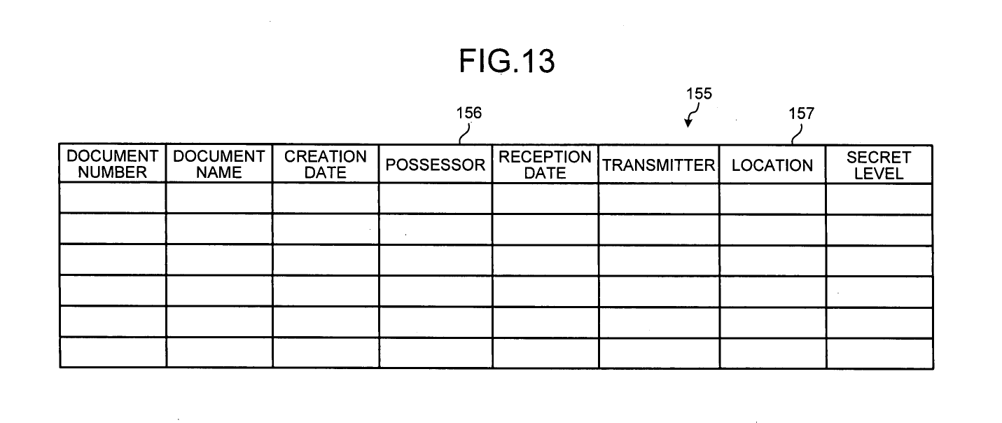

Accordingly, the document management server 32 according to the embodiment receives and stores an electronic document or the like together with the metadata. FIG. 13 illustrates a list of metadata items for each electronic document. For example, a data list 155 on which metadata items are listed in the row is stored in a storage unit 154 of the document management server 32 as illustrated in FIG. 13. Metadata of a loaded electronic document or the like is recorded in a predetermined place. In order to perform the operations efficiently and accurately, integrated code numbers of the metadata are preferably used. If the code numbers determined with industrial standard or de facto standard are used, metadata can be utilized for all the electronic documents and the like that have been created by using devices manufactured by any manufacturers in an integrated manner.

A “possessor” 156 illustrated in the'data list 155 in FIG. 13 is not always the same as a creator. A person who has received an electronic document or the like from the creator corresponds to the possessor of the electronic document or the like. That is to say, a person who tries to store the electronic document or the like in the document management server 32 by using a device at this time corresponds to the possessor. Although the creator is identical to the possessor in many cases, the creator and the possessor are different from each other in some cases. Therefore, the items of the creator and the possessor are separately set. In terms of a “location” 157, location information (longitude and latitude information, or prefectures or city information) on a map where an image has been shot can be obtained if a digital camera or a digital video camera having a GPS function is used. Such location information of an electronic image shot by a mobile phone with GPS and camera functions can be obtained as metadata.

In addition, since an electronic document or the like is protected by copyright in some cases, the electronic document or the like may have a name of a person having such copyright as information. With this, the electronic document can have the following control function. When the possessor of the electronic document or the like, who is different from a person having the copyright, tries to change contents of the electronic document or the like or perform an operation that is required to be permitted by the person having the copyright, such actions can be prohibited.

However, metadata does not always include the same items depending on types of electronic documents and the like. In the embodiment, it is supposed that there arises no problem even when the electronic document or the like does not have some metadata and fields corresponding to some of the items on the table are not filled. Specifically, a state where some items are filled and others are not filled causes no problem. In other words, an electronic document without corresponding metadata is not extracted when searched because a user uses metadata when the user wants to search and retrieve an electronic document. However, if an electronic document has corresponding metadata, the electronic document becomes a target to be searched and a necessary electronic document or the like can be retrieved by the search with high accuracy.

Hereinbefore, description has been made with focusing on document management in the real world and the electronic world. Next, document management in the three-dimensional virtual space that is the so-called Metaverse world, that is, the private three-dimensional virtual space provider site 2 in FIG. 1 is described.

A Metaverse server 28 illustrated in FIG. 12 is a server that stores and starts up various types of software needed for managing the Metaverse. Furthermore, a private object DB 25 that stores therein various products created in the Metaverse, such as avatars, lands, buildings, parts, accessories, various devices, documents, and marks is provided. The number of Metaverse servers and DBs needed for managing the Metaverse are different depending on policies of the managers. In the example, these necessary servers are collectively expressed as a Metaverse server.

For example, Japanese Patent Application Laid-open No. 2004-178257 discloses a Metaverse server including a first storage unit that stores therein stereoscopic image display data, a second storage unit that stores therein a virtual room that has been transmitted from a terminal, and a storage unit that stores therein software for creating the virtual room. Furthermore, the Metaverse server may be a single server in the disclosure.

Various businesses have been developed in the Metaverse. For example, a showroom is built on a user's island in the Metaverse and user's products are displayed. Then, an avatar shop staff explains the products for a visiting avatar. As another example, when an avatar visits a company before joining the company, a company explanation meeting is held by using the Metaverse. Recently, there is a company that tries to utilize the Metaverse only in the company as groupware. For example, the groupware called NOTES is famous as an in-house communication tool. The Metaverse is tried to be utilized as a unit instead of the NOTES.

In any cases, an opportunity in which an electronic document or the like is created in the Metaverse is considered to occur. A creator of an electronic document or the like (referred to as a Metaverse document) that has been created in the Metaverse stores the Metaverse document in the Metaverse or in a document server in the electronic world.

Furthermore, an electronic document or the like that has been created in the electronic world is retrieved in the Metaverse and is shown or handed over to other avatars in some cases. With focusing on the Metaverse, the Metaverse is set as “inside” and worlds outside the Metaverse are set as “outside”. In this case, exchange flows of the electronic document or the like including inside to inside, inside to outside, and outside to inside are generated. Furthermore, exchange flows including inside to outside to inside, and outside to inside to outside are also generated.

In such a manner, there arises an unexpected problem if an electronic document or the like is exchanged between the Metaverse world and the electronic world. Typically, a user has to subscribe and log in to the Metaverse by inputting an assigned user name and a password in order to enter the Metaverse because the Metaverse is managed by a specified company. Furthermore, various products in the specific Metaverse are closed in the Metaverse in normal cases. That is to say, it is difficult to take out the products to the outside and take products from the outside into the Metaverse, vice versa. Even if there are difficulties in performing such operations today, the difficulties will be eliminated in future reliably with development of techniques and change of user's needs.

In the embodiment, an electronic document or the like that has been created in the Metaverse, and an electronic document or the like that has been received from another avatar in the Metaverse are stored in the temporary storage document server 158 for the Metaverse together with metadata attached to the electronic documents at the time of the creation or reception (see, FIG. 12). In the Metaverse, the temporary storage document server 158 can be seen by the avatar as the “briefcase” 138. That is to say, the avatar stores a Metaverse document in the temporary storage document server 158 by storing an electronic document or the like that the avatar has created or an electronic document received by another avatar in the briefcase 138. The temporary storage document server 158 has a function of making storage formats of the documents and the like be uniform so as to finally store Metaverse documents in the document management server 32 in the electronic world. Furthermore, the temporary storage document server 158 includes a transmission unit 159 that transmits the Metaverse document stored therein to the document management server 32 in accordance with a predetermined operation, for example, at a timing at which the avatar logs out of the Metaverse, or a direction from the avatar himself/herself. At this time, metadata is transmitted to the document management server 32 together with the Metaverse document and recorded in the storage unit 154 in a predetermined format. A “creation world” is newly provided as a metadata item in the document management server 32 that can also store therein Metaverse documents. That is to say, the “creation world” is an item that makes it possible to identify whether a product is created in the electronic world or created in the Metaverse. Furthermore, if the age of multiverse (a state where a plurality of Metaverses are present) comes, the metadata can be made to have a name of a Metaverse such that the Metaverse in which the product has been created can be identified. With this, the information can be utilized so as to prevent a Metaverse document created in a Metaverse from being transmitted to other Metaverses.

Next, a case where an avatar wants to get an electronic document or the like that the avatar himself/herself possesses in the electronic world to the Metaverse world is described.

The avatar utilizes a search bar provided on a briefcase in the Metaverse or on a predetermined window so as to input characteristics of the electronic document that the avatar wants to get as a keyword. The electronic document is searched based on the input keyword, and the search result is transmitted to the temporary storage document server 158. A transmission unit 159a that transmits the search result is also provided in the document management server 32 (see, FIG. 12).

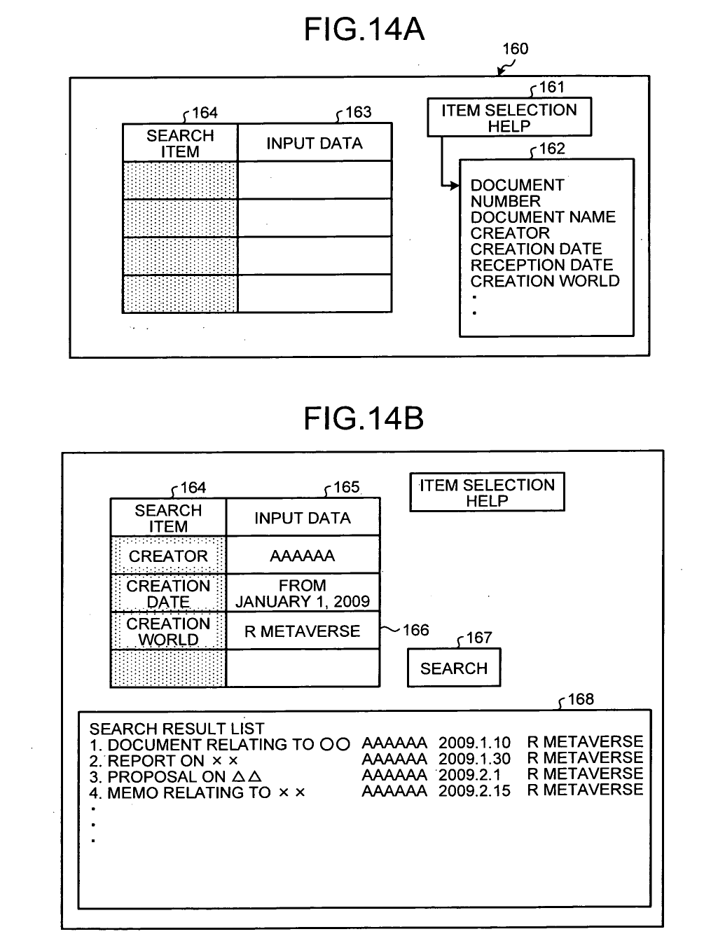

An example supporting the input method is described with reference to FIG. 14A and FIG. 14B.

FIG. 14A illustrates an input screen 160 displayed when a user uses a search screen on the terminal 35 (personal computer), or when an avatar uses a search screen in the Metaverse. In order to inform a user about items of metadata that can be searched, a pull-down menu 162 is displayed by pressing an item selection HELP button 161. A list of the items that can be searched as metadata is displayed on the menu 162. If “creator” on the list is clicked to be selected, the “creator” is displayed on a search item 164 on a window 163 displayed at the left side. FIG. 14B is a view illustrating a screen on which the search result is displayed. Since items can be successively selected, it is assumed that “creation date” and “creation world” are selected successively. Then, three items of “creator”, “creation date” and “creation world” that have been selected before are displayed on a field of the search item 164 as illustrated in FIG. 14B. Subsequently, the user inputs data to be retrieved on an input data field 165. A type or a kind of Metaverse is input on a creation world field 166. When the input by the user is completed, the user presses a search button 167. Electronic documents and the like in the document management server 32 are searched based on the search key. A search server can be separately provided (not illustrated). If the search is completed, the corresponding electronic documents and the like are displayed on a field of a search result list 168. At this time, as displayed items, a name of the document is displayed as an essential item and metadata matched with the searched items is also displayed.

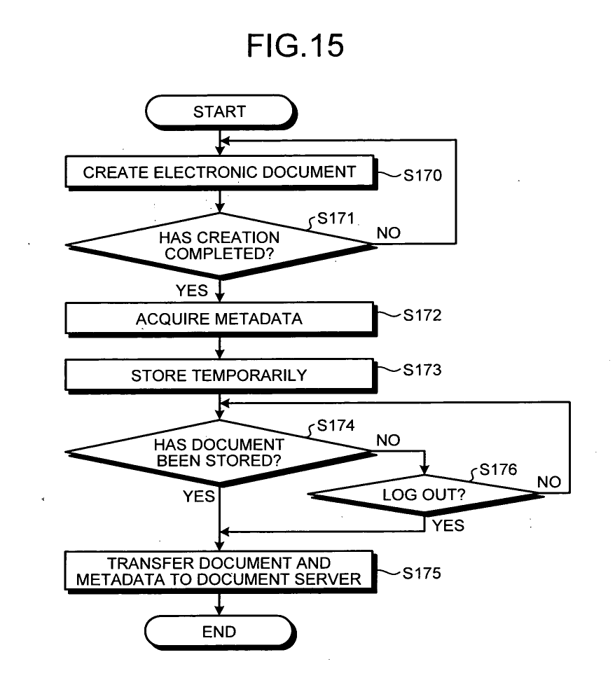

FIG. 15 is a flowchart illustrating operations of transmission and storage of an electronic document according to the embodiment.

A flow of transmitting a created electronic document or the like to the document management server 32 and storing the created electronic document or the like therein is described with reference to FIG. 15. At first, an electronic document is created by the terminal 35 (step S170). Then, it is judged whether the creation of the electronic document is completed (step S171). If the creation of the electronic document is judged to be completed, metadata relating to the electronic document is acquired (step S172). If the metadata is acquired, the electronic document and the metadata are temporarily stored in combination (step S173). The electronic document and the metadata are temporarily stored in a storage unit (not illustrated) of the temporary storage document server 158. Then, it is judged whether the created document is finally stored (step S174). If the created document is judged to be stored (Yes at step S174), the electronic document and the metadata are transferred from the temporary storage document server 158 to the document management server 32 in combination (step S175). On the other hand, if the avatar does not judge to store the document (No at step S174), it is judged whether the user physically logs out of the Metaverse (step S176). If the user does not log out of the Metaverse (No at step S176), the process returns to step S174. If the user logs out of the Metaverse (Yes at step S176), the electronic document and the metadata thereof that have been stored in the temporary storage document server 158 are transferred to the document management server 32 in combination in the same manner as described above (step S175).

In this case, a metadata acquisition unit 177 (see, FIG. 12) is provided on the temporary storage document server 158.

When the electronic document is created or received by the terminal 35 in the electronic world, metadata attached to the electronic document has to be acquired. Software as the metadata acquisition unit 177 is stored in the terminal 35. It is needless to say that the metadata acquisition unit may be provided on the document management server 32, and metadata attached to an electronic document or the like may be acquired when the electronic document or the like is received from the terminal 35. However, when an electronic document or the like that has not been created by the terminal 35 is obtained through external memories 152 and 153 or the Internet, there is a risk in that metadata thereof cannot be obtained reliably. In order to avoid such a risk, the metadata acquisition unit 177 is desirably provided on the terminal 35.

According to the present invention, even electronic documents and the like that have been created in or received from different worlds can be stored and managed in a unified manner. This produces the effect of making search, browsing, and utilization of documents more convenient.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management system comprising:
a document management server; and
a temporary storage document server that stores therein an electronic document created or received in a Metaverse, wherein
the document management server includes:
a document storage unit that stores therein an electronic document and metadata transmitted from a terminal device and the temporary storage document server in a correspondence manner; and
a first transmission unit that transmits the electronic document searched from the document storage unit based on a search key transmitted from the terminal device to the terminal device, and
the temporary storage document server includes:
a temporary storage unit that stores therein an electronic document created or received in the Metaverse and metadata in a correspondence manner; and
a second transmission unit that transmits the electronic document and metadata stored in the temporary storage unit to the document management server.

2. The management system according to claim 1, wherein
the document management server further includes a classification unit that classifies the electronic document into a specified classification item and stores the classified electronic document in the document storage unit.

3. The management system according to claim 2, wherein
the classification unit adds a classification item based on the metadata corresponding to the electronic document when the classification item is not specified, classifies the electronic document into the added classification item, and stores the classified electronic document in the document storage unit.

4. The management system according to claim 1, wherein
the temporary storage document server further includes a metadata acquisition unit that acquires metadata of an electronic document transmitted from the terminal device, and
the document storage unit stores therein the metadata acquired by the metadata acquisition unit and an electronic document received from the terminal device in a correspondence manner.

5. The management system according to claim 1, wherein
the document management server further includes a third transmission unit that transmits the electronic document stored in the document storage unit to a virtual storage unit included in the Metaverse.

6. The management system according to claim 5, wherein
the metadata includes identification information for identifying a Metaverse in which the electronic document has been created, and
the third transmission unit does not transmit the electronic document when the identification information included in the metadata corresponding to the electronic document and the identification information of the Metaverse including the virtual storage unit are not identical to each other.

7. A management method that is executed in a management system including a document management server, and a temporary storage document server that stores therein an electronic document created or received in a Metaverse, the method comprising:
a document storage process in which the document management server stores an electronic document and metadata transmitted from a terminal device and the temporary storage document server in a document storage unit in a correspondence manner;
a first transmission process in which the document management server transmits the electronic document searched from the document storage unit based on a search key transmitted from the terminal device to the terminal device;
a temporary storage process in which the temporary storage document server stores an electronic document created or received in the Metaverse and metadata in a temporary storage unit in a correspondence manner; and
a second transmission process in which the temporary storage document server transmits the electronic document and metadata stored in the temporary storage unit to the document management server.

8. A temporary storage document server in a management system comprising
a document management server; and
the temporary storage document server that stores therein an electronic document created or received in a Metaverse, wherein
the document management server includes:
a document storage unit that stores therein an electronic document and metadata transmitted from a terminal device and the temporary storage document server in a correspondence manner; and
a first transmission unit that transmits the electronic document searched from the document storage unit based on a search key transmitted from the terminal device to the terminal device, and
the temporary storage document server includes:
a temporary storage unit that stores therein an electronic document created or received in the Metaverse and metadata in a correspondence manner; and
a second transmission unit that transmits the electronic document and metadata stored in the temporary storage unit to the document management server.
